(19) United States
(12) Patent Application Publication
(10) Pub. No.: US 2006/0290683 A1
(43) Pub. Date: Dec. 28, 2006

(54) Device with light-guiding layer

(75) Inventors: Donato Pasquariello, Eindhoven (NL); Galileo June Adeva Destura, Eindhoven (NL); Hugo Johan Cornelissen, Eindhoven (NL); Andrea Giraldo, Eindhoven (NL); Michel Cornelis Josephus Marie Vissenberg, Eindhoven (NL); Martin Jacobus Johan Jak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,613

(22) PCT Filed: Sep. 21, 2004
(86) PCT No.: PCT/IB04/51806

§ 371 Date: Mar. 17, 2006

(30) Foreign Application Priority Data
Sep. 22, 2003 (EP) 03103492.9

(51) Int. Cl. G09G 5/00

(52) U.S. Cl. 345/175

(57) ABSTRACT

Devices (1) comprising light detectors (11-14) for detecting light and in response generating detection information, and light-guiding layers (15) comprising outer sides for guiding incident light (21) arriving at the outer sides and originating from input devices (20) towards the light detectors (11-14) are provided with converters (16) for converting the detection information into further information for taking into account one or more angles between the incident light (21) and an axis perpendicular to the light-guiding layer (15). As a result, one/two-dimensional corrections of locations of incidence can be made, and one/two-dimensional estimations of directions of user locations can be made, to adapt device parameters such as rotation, zooming, scrolling, volume, contrast, brightness or sound optimizing parameters, or to select a user from a plurality of users operating their own input devices (20). The devices (1) may further comprise displays (2), with the light-guiding layers (15) comprising inner sides for guiding light arriving at the inner sides and originating from the displays (2) to the outer sides.

### FIELD OF THE INVENTION

The present invention relates to a device, and also relates to a display, to an extension, to a method and to a processor program product.

Examples of such a device are television sets, display monitors, PCs and laptops and other consumer devices. An example of such a display monitor is an electronic ink display, a plasma display, a liquid crystal display or a light emitting diode display.

### BACKGROUND ART

European Patent EP 0 572 182 B1 discloses a display unit with an integral optical input apparatus. The display unit has a liquid crystal display panel comprising conductors in X-axis and Y-axis directions disposed on one of the substrates of the panel. These conductors are optical wave-guides for guiding light parallel to the surfaces of the substrates. A light-receiving element for sensing an optical signal is disposed in an end portion of each of the optical wave-guides.

When light emitted from an optical pen comes into contact with the substrate, X and Y coordinates of the contact portion of the emitted light are determined by the light receiving elements in the form of, e.g., photo sensors. A problem with the device of EP 0 572 182 B1 is that the optical wave-guides are formed within the substrate, or substrates, of the panel. This makes the display unit difficult and expensive to manufacture, since the processes used for forming the wave-guide in the substrate are rather complex. Moreover, the fact that the wave-guides are formed in the substrate is prejudicial to the flexibility in manufacture of the display unit, since the wave-guides must in practice be formed in the substrate at the time of manufacture and thus cannot be added to the display unit after manufacture of the same.

To solve this problem, the non-pre-published European Patent Application Ser. No. 03103492.9 (Attorney docket NL 031105) filed Sep. 22, 2003, for “COORDINATE DETECTION SYSTEM FOR A DISPLAY DEVICE” and herewith incorporated by reference, discloses introducing a light-guiding layer having an optical structure arranged to confine a fraction of incident light from the display device exterior in the light-guiding layer. The incident light is generated by a remote input device operable by a user for interacting with the display. The confined light is transmitted through the layer towards light-detecting means for detecting the confined light and relating the detecting of the confined light to an input position. This display device detects an input position on a screen of the display device, the display device being easy to manufacture and the image quality of the display being affected only slightly if at all. Within this context, the expression “input position’ should be understood to mean the screen coordinate where user interaction takes place, e.g., where light emitted by an optical pen enters the screen.

### SUMMARY OF THE INVENTION

It is an object of the invention, inter alia, to provide a device, which is relatively advanced. Further objects of the invention are, inter alia, to provide a display, an extension, a method and a processor program product, which are relatively advanced.

The device according to the invention comprises light detector means for detecting light and in response generating detection information; a light-guiding layer comprising an outer side for guiding incident light arriving at the outer side and originating from an input device towards the light detector means; and a converter for converting the detection information into further information for taking into account an angle between the incident light and a predetermined direction relative to the layer, e.g., an axis substantially perpendicular to the light-guiding layer.

Compared to the system in non-pre-published European Patent Application Ser. No. 03103492.9, referred to above, a converter has been added. This converter forms, for example, part of a processor system and takes the form of, for example, hardware or software components or is a mixture of both. The light-guiding layer guides the incident light towards the light detector means through internal reflections inside of the light-guiding layer. The incident light can hit the light-guiding layer either perpendicularly or at an oblique angle unequal to zero. Because of the guidance inside the light-guiding layer being based on internal reflections, incident light hitting the light-guiding layer at different angles of incidence will result in different detection information being generated by the light detector means. The converter converts first (second) detection information into first (second) further information for taking into account a first (second) angle between the incident light and the predetermined direction, e.g., an axis perpendicular to the light-guiding layer. This axis corresponds with the light-guiding layer's normal. As a result, the device according to the invention is relatively advanced.

An embodiment of the device according to the invention is defined by the light detector means comprising a first detector at a first side of the light-guiding layer for generating a first detection signal x₁ and a second detector at a second side of the light-guiding layer for generating a second detection signal x₂, the first and second sides forming opposite sides. In case of the light-guiding layer being in a vertical position, the first detector detects first light arriving via the light-guiding layer at the lower horizontal side of the light-guiding layer, and the second detector detects second light arriving via the light-guiding layer at the upper horizontal side of the light-guiding layer. Thereto, the first and second detector may each comprise two or more sub-detectors. The first detector generates the first detection signal x₁ and the second detector generates the second detection signal x₂, with the first detection signal x₁ and the second detection signal x₂ for example representing distances to for example the left vertical side of the light-guiding layer. In case of the incident light arriving via a horizontal plane, which horizontal plane is perpendicular to the light-guiding layer, with the incident light not arriving perpendicular to the light-guiding layer, the first detection signal x₁ and the second detection signal x₂ will generally be different from each other.

An embodiment of the device according to the invention is defined by the light detectors further comprising a third detector at a third side of the light-guiding layer for generating a third detection signal y. In case of the light-guiding layer being in a vertical position, the third detector detects third light arriving via the light-guiding layer at a left or right vertical side of the light-guiding layer. Thereto, the third detector may comprise two or more sub-detectors. The third detector generates the third detection signal y, with the third detection signal y for example representing a distance to for example the upper horizontal side of the light-guiding layer.

An embodiment of the device according to the invention is defined by the further information comprising a location of incidence x, y, wherein x is a function of x₁, X₂, and y. This function for example defines x=[yx₁+(y−H)x₂]/(2y−H), wherein H equals the height of the light-guiding layer. Accordingly, x₁, x₂, and y are measured and x can then be calculated. This embodiment allows a one-dimensional correction of the location of incidence, which correction may be necessary owing to the fact that there is an angle between the incident light and an axis perpendicular to the light-guiding layer. Alternative equations can be written without departing from the scope of this invention.

An embodiment of the device according to the invention is defined by the further information comprising an angle of incidence, which angle of incidence is linearly dependent on α, wherein tan α is a function of x₁, x₂, and y. This function for example defines tan α=(x₂−xₗ)/(2y−H), wherein H equals the height of the light-guiding layer. So, x₁, x₂, and y are measured and α can then be calculated. This embodiment allows a one-dimensional estimation of a direction of a user location, which direction results from the fact that there is an angle between the incident light and an axis perpendicular to the light-guiding layer. Alternative equations can be written without departing from the scope of this invention.

An embodiment of the device according to the invention is defined by the light detectors comprising a third detector at a third side of the light-guiding layer for generating a third detection signal y₁ and a fourth detector at a fourth side of the light-guiding layer for generating a fourth detection signal y₂, which third and fourth sides are opposite sides. In case of the light-guiding layer being in a vertical position, the third detector detects third light arriving via the light-guiding layer at the left vertical side of the light-guiding layer, and the fourth detector detects fourth light arriving via the light-guiding layer at the right vertical side of the light-guiding layer. Thereto, the third and fourth detector may each comprise two or more sub-detectors. The third detector generates the third detection signal y₁ and the fourth detector generates the fourth detection signal y₂, with the third detection signal y₁ and the fourth detection signal y₂ for example representing distances to for example the upper horizontal side of the light-guiding layer. In case of the incident light arriving via a vertical plane, which vertical plane is perpendicular to the light-guiding layer, with the incident light not arriving perpendicular to the light-guiding layer, the third detection signal y₁ and the fourth detection signal y₂ will generally be different from each other.

An embodiment of the device according to the invention is defined by the further information comprising a location of incidence x, y, wherein x and y are functions of x₁, x₂, y₁, and y₂. These functions for example define x=[yx₁+(y−H)x₂]/(2y−H), wherein H equals the height of the light-guiding layer, and y=[(x−B)y₁+xy₂]/(2x−B), wherein B equals the width of the light-guiding layer. So, x₁, x₂, y₁, and y₂ are measured and x and y can then be calculated. Because x also depends on y and vice versa, additional information is necessary to solve both equations. This additional information can for example be derived from history information and/or from given limitations, such as the fact that x, and y should be within the dimensions of the light-guiding layer. This embodiment allows a two-dimensional correction of the location of incidence, which correction may be necessary owing to the fact that there are angles between the incident light and an axis perpendicular to the light-guiding layer. Alternative equations can be used without departing from the scope of this invention.

An embodiment of the device according to the invention is defined by the further information comprising a first and a second angle of incidence, wherein the first angle of incidence depends linearly on α and the second angle of incidence depends linearly on β, tan α and tan β being functions of x₁, x₂, y₁, and y₂. These functions specify, e.g., tan α=(x₂−x₁)/(2y−H), wherein H equals the height of the light-guiding layer, and tan β=(y₂−y₁)/(2x−B), wherein B equals the width of the light-guiding layer. So, x₁, x₂, y₁, and y₂ are measured and α and β can then be calculated. Because α also depends on y and β also depends on x, additional information is necessary to solve both equations. This additional information can be derived, e.g., from history information and/or from given limitations, such as the fact that the magnitudes of α and β should be within certain limits. This embodiment allows a two-dimensional estimation of a direction of a user location. The direction results from the fact that there are angles between the incident light and an axis perpendicular to the light-guiding layer. Alternative equations can be used without departing from the scope of this invention.

An embodiment of the device according to the invention is defined by further comprising a display; and the light-guiding layer comprising an inner side for guiding light arriving at the inner side and originating from the display to the outer side. The display provides images to a user, who operates the remote input device for interaction with (parts of the) images.

An embodiment of the device according to the invention is defined by further comprising an adapter for adapting a device parameter in response to the further information. This adapter allows the (automatic) adjustment of audio and/or video parameters in dependence of the angle(s) between the incident light and an axis perpendicular to the light-guiding layer.

An embodiment of the device according to the invention is defined by the device parameter comprising a rotation parameter defining a rotation of a 3D object displayed on a display or a zooming parameter or a scrolling parameter or a volume parameter or a contrast parameter or a brightness parameter or a sound optimizing parameter. These audio and/or video parameters are preferably to be adjusted automatically.

An embodiment of the device according to the invention is defined by further comprising a selector for selecting, in response to the further information, a user from a plurality of users each one operating his/her own input device. This selector allows the (automatic) selection of users in dependence of the angle(s) between the incident light and an axis perpendicular to the light-guiding layer, for example to control a game to be played via the display device or for example to individualize user settings.

Embodiments of the display according to the invention and of the extension according to the invention and of the method according to the invention and of the processor program product according to the invention correspond with the embodiments of the device according to the invention. As for the processor program product in the invention, this program product is for use on a data processing system, e.g., a home network or a PC or an interactive TV. The system comprises light detector means for detecting light and in response generating detection information, and a light-guiding layer that has an outer side for guiding incident light arriving at the outer side and originating from an input device towards the light detectors. The processor program product comprises converter means to convert the detection information into further information for taking into account an angle between the incident light and a predetermined direction relative to the light-guiding layer, e.g., an axis substantially perpendicular to the light-guiding layer. For clarity, the expression “processor program product” is meant to cover control software, e.g., on a physical carrier or made available via a data network, that is to be run on a data processor in order to implement the functionality indicated. Such product may be an after-market add-on supplied by the manufacturer of the device specified above.

The invention is based upon an insight, inter alia, that the guidance inside the light-guiding layer is based on internal reflections, whereby incident light hitting the light-guiding layer at different angles of incidence results in the light detectors generating different detection information, and is based upon a basic idea, inter alia, that a converter should convert first (second) detection information into first (second) further information for taking into account a first (second) angle between the incident light and the axis perpendicular to the light-guiding layer.

The invention solves the problem, inter alia, to provide a device, which is relatively advanced, and is advantageous, inter alia, in that one/two-dimensional corrections of locations of incidence and/or one/two-dimensional estimations of directions of user locations can be made.

These and other aspects of the invention will be apparent from and elucidated with reference to the embodiments(s) described hereinafter.

### BRIEF DESCRIPTION OF THE DRAWINGS

The invention is further explained, by way of example and with reference to the accompanying drawing wherein:

FIG. 1 is a diagram of a device comprising a display according to the invention or an extension according to the invention;

FIG. 2 is a diagram of a vertical light-guiding layer receiving incident light via a horizontal plane, the incident light deviating from the light-guiding layer's normal through a single angle;

FIG. 3 is a diagram of a vertical light-guiding layer receiving incident light via a non-horizontal plane, the incident light deviating from the light-guiding layer's normal through two angles;

FIG. 4 is a diagram of a device in the invention with the light-guiding layer shown in cross-section; and

FIG. 5 illustrates the angular shift as a function of an angle of incidence.

### DETAILED EMBODIMENTS

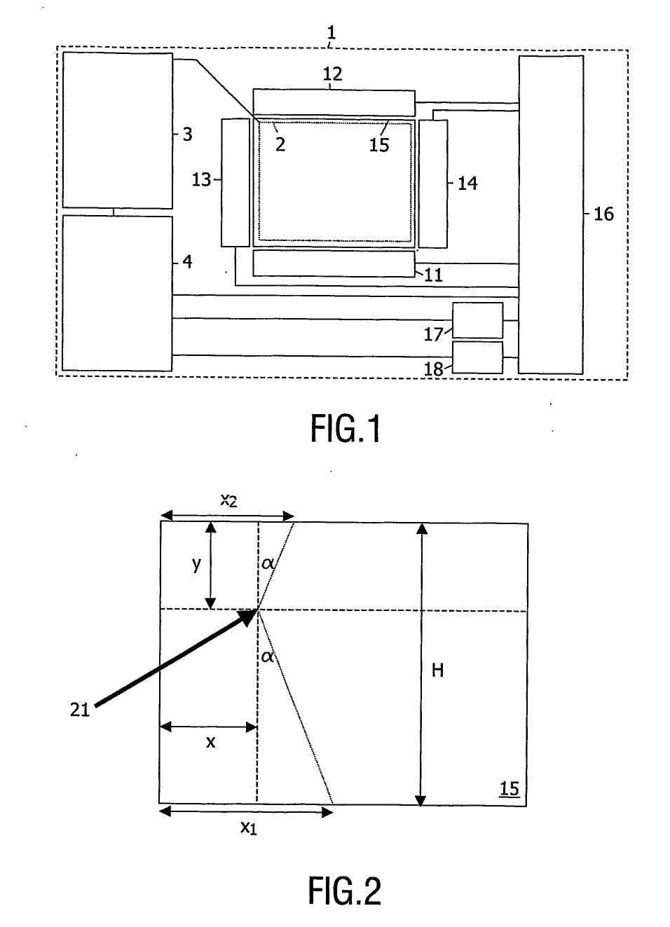

The device 1 according to the invention shown in FIG. 1 comprises a display 2 coupled to a display driver 3. The display driver 3 is coupled to a processor system 4 that comprises, e.g., an input interface (not shown) for receiving signals to be displayed and/or a man-machine-interface or MMI (not shown) for generating/manipulating signals to be displayed and/or a storage interface (not shown) for storing signals to be displayed, etc. The device 1 further comprises a display extension 11-16 comprising light detectors 11-14. A light receiving side of light detectors 11-14 is coupled to, or is located closely to, a light-guiding layer 15. An electrical signal generating side of light detectors 11-14 is coupled to a converter 16. The light detectors 11-14 comprise a first detector 11 at a lower horizontal side of the light-guiding layer 15, a second detector 12 at an upper horizontal side of the light-guiding layer 15, a third detector 13 at a left vertical side of the light-guiding layer 15 and a fourth detector 14 at a right vertical side of the light-guiding layer 15. The converter 16 is further coupled to the processor system 4, to an adapter 17 and to a selector 18. The adapter 17 and the selector 18 are further coupled to the processor system 4. The display extension 11-16 may form part of a “display 2 according to the invention”, or may form part, together with a “prior art display 2”, of the “device 1 according to the invention”.

The light-guiding layer 15 is described in greater detail in the non-pre-published European Patent Application Ser. No. 03103492.9 (attorney docket NL 031105), referred to above and herewith incorporated by reference. Generally, this light-guiding layer 15 comprises an outer side and an inner side for guiding incident light arriving at the outer side and originating from an input device towards the light detectors 11-14, and for guiding light arriving at the inner side and originating from the display 2 to the outer side to allow a user to watch an image on the display 2.

The vertical light-guiding layer 15 in FIG. 2 receives light 21 incident via a horizontal plane. The incident light 21 deviates from the light-guiding layer's normal through a single angle. As a result, the respective light detectors 11, 12, and 13 generate the respective detection signals x₁, x₂, and y, instead of the respective detection signals x, x, and y. The first detection signal x₁ and the second detection signal x₂ represent, for example, distances to, e.g., the left vertical side of the light-guiding layer 15. In case of the incident light 21 arriving via a horizontal plane perpendicular to the light-guiding layer 15, and with the incident light 21 not arriving perpendicular to the light-guiding layer 15, the first detection signal x₁ and the second detection signal x₂ will generally be different from each other. The third detection signal y represents, for example, a distance to e.g., the upper horizontal side of the light-guiding layer 15.

The converter 16 in FIG. 1 receives this detection information x₁, x₂, and y and converts it into further information for taking into account the angle between the incident light 21 and an axis perpendicular to the light-guiding layer 15. This further information may, for example, comprise coordinates of a location of incidence x and y, wherein x depends on x₁, x₂, and y. This dependence specifies x for example as x=[yx1+(y−H)x₂]/(2y−H), wherein H equals the height of the light-guiding layer 15. So, x₁,x₂, and y are measured and x can then be calculated. This embodiment allows a one-dimensional correction of the location of incidence. This correction may be necessary owing to the fact that there is an angle between the incident light 21 and the axis perpendicular to the light-guiding layer 15. Alternative dependences can be used without departing from the scope of this invention. This location of incidence having an improved accuracy is then supplied from the converter 16 to the processor system 4, etc.

The further information may alternatively comprise an angle of incidence. This angle of incidence depends linearly on the angle α, wherein tan α is a function of x₁, X₂, and y. For example, this function defines tan α=(x₂−x₁)/(2y−I−), wherein H equals the height of the light-guiding layer. So, x₁, x₂, and y are measured and α can then be calculated. This embodiment allows a one-dimensional estimation of a direction of a user location. The direction results from the fact that there is an angle between the incident light 21 and an axis perpendicular to the light-guiding layer 15. Alternative functions can be used without departing from the scope of this invention. This angle of incidence is then supplied from the converter 16 to the adapter 17 and/or the selector 18 as is further discussed below.

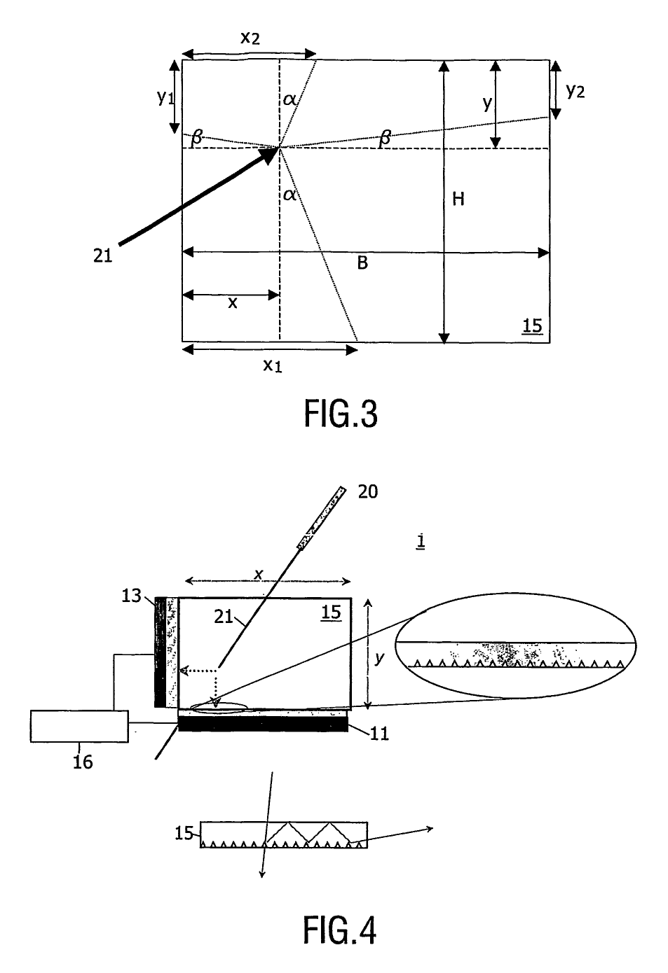

The vertical light-guiding layer 15 in FIG. 3 receives incident light 21 via a non-horizontal plane. The incident light 21 deviates from the light-guiding layer's normal through a first and a second angle. The first angle is situated in a horizontal plane, and the second angle is formed by the angle between this horizontal plane and the non-horizontal plane. As a result, the respective light detectors 11, 12, 13, 14 generate the respective detection signals x₁, x₂, y₁, and y₂, instead of the respective detection signals x, x, y, and y. The third detection signal y₁ and the fourth detection signal y₂ represent, for example, distances to the upper horizontal side of the light-guiding layer 15. In case of the incident light 21 arriving via a vertical plane perpendicular to the light-guiding layer 15, and with the incident light 21 not arriving perpendicular to the light-guiding layer 15, the third detection signal y₁ and the fourth detection signal y₂ will generally be different from each other.

The converter 16 in FIG. 1 receives this detection information x₁, x₂, y₁, and y₂ and converts it into further information for taking into account the angles between the incident light 21 and an axis perpendicular to the light-guiding layer 15. This further information may, for example, comprise coordinates of a location of incidence x and y, wherein x and y are functions of x₁, x₂, y₁, and y₂. These functions are, for example, x=[yx₁+(y−H)x₂]/(2y−H), wherein H equals the height of the light-guiding layer, and y=[(x−B)y₁+xy₂]/(2x−B), wherein B equals the width of the light-guiding layer. So, x₁, x₂, y₁, and y₂ are measured and x and y can then be calculated. Because x also depends on y and vice versa, additional information is necessary to solve both equations. This additional information can, for example, be derived from history information and/or from given limitations, such as the fact that x and y should be within the dimensions of the light-guiding layer. This embodiment allows a two-dimensional correction of the location of incidence. The correction may be necessary owing to the fact that there are angles between the incident light and an axis perpendicular to the light-guiding layer. Alternative equations can be used without departing from the scope of this invention. This location of incidence, having an improved accuracy, is then supplied from the converter 16 to the processor system 4, etc.

The further information may alternatively comprise a first and a second angle of incidence. The first angle of incidence depends linearly on the angle α and the second angle of incidence depends linearly on angle β, wherein tan α and tan β are functions of x₁,x₂,y₁,y₂. These functions are, e.g., tan α=(x₂−x₁)/(2y−H), wherein H equals the height of the light-guiding layer, and tan β=(y₂−y₁)/(2x−B), wherein B equals the width of the light-guiding layer. So, x₁,x₂, y₁,y₂ are measured and α and β can then be calculated. Because α also depends on y and β also depends on x, additional information is necessary to solve both equations. This additional information can be derived, e.g., from history information and/or from given limitations, such as the fact that α, β should be within certain limits. This embodiment allows a two-dimensional estimation of a direction of a user location. The direction results from the fact that there are angles between the incident light and an axis perpendicular to the light-guiding layer. Alternative equations can be used without departing from the scope of this invention. These angles of incidence are then supplied from the converter 16 to the adapter 17 and/or the selector 18 as further discussed below.

The adapter 17 adapts a device parameter in response to the further information comprising one or more angles of incidence. This allows the (automatic) adjustment of audio and/or video parameters in dependence on the angle(s) between the incident light 21 and an axis perpendicular to the light-guiding layer 15. Such a device parameter may comprise a rotation parameter defining a rotation of a 3D object displayed on the display or a zooming parameter, a scrolling parameter, a volume parameter, a contrast parameter, a brightness parameter or a sound optimizing parameter, etc. Accordingly, a user watching the display and operating the input device at one or more angles of incidence automatically gets a 3D object rotated in his/her direction, and/or gets automatically more or less zooming, more or less scrolling, more or less volume, more or less contrast, more or less brightness, and/or adapted sound, etc.

In response to the further information comprising one or more angles of incidence, the selector 18 selects a user from a plurality of users each one operating his/her own input device. this allows the (automatic) selection of users in dependence on the angle(s) between the incident light 21 and an axis perpendicular to the light-guiding layer 15, for example to control a game to be played via the device 1, or to individualize user settings.

Alternatively, the converter 16 may form part of the processor system 4, for example in the form of hardware or software or a mixture of both; the adapter 17 and/or the selector 18 may form part of the processor system 4, for example in the form of hardware or software or a mixture of both; and the adapter 17 and/or the selector 18 may form part of the converter 16 for example in the form of hardware or software or a mixture of both.

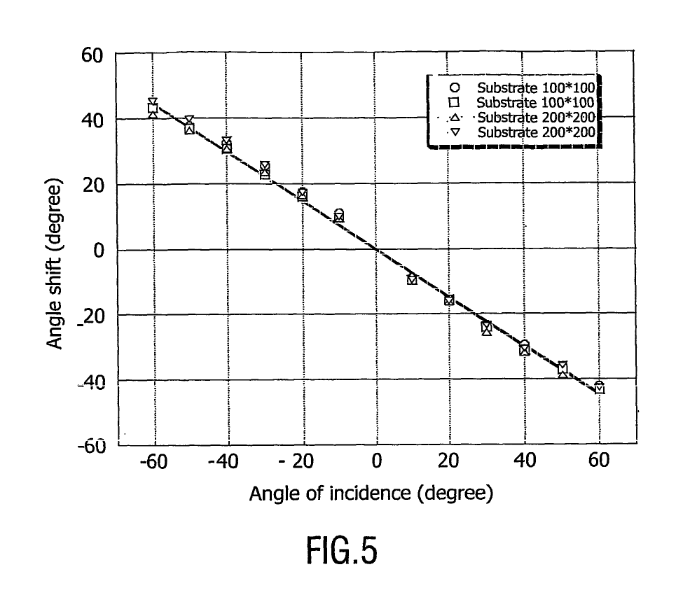

The device 1 of the invention in FIG. 4, the light-guiding layer 15 also being shown in cross-section, further comprises an input device 20 for generating the incident light 21. The first detector 11 and the third detector 13 are coupled to the converter 16.

The angular shift α, β as a function of the angle of incidence is shown in FIG. 5. Clearly, a linear relationship is present.

Other (remotely controlled) devices with or without a display are not to be excluded, such as, for example, audio tuners, audio amplifiers, audio/video players/recorders and audio speakers that can individually be controlled.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A device (1) comprising: light detector means (11-14) for detecting light and in response generating detection information; a light-guiding layer (15) comprising an outer side for guiding incident light (21) arriving at the outer side and originating from an input device (20) towards the light detector means (11-14); and a converter (16) for converting the detection information into further information for taking into account an angle between the incident light (21) and a predetermined direction relative to the light-guiding layer (15).

2. The device (1) of claim 1, wherein the light detector means (11-14) comprises a first detector (11) at a first side of the light-guiding layer (15) for generating a first detection signal x₁ and a second detector (12) at a second side of the light-guiding layer (15) for generating a second detection signal x₂, and wherein the first and second sides are opposite sides of the layer.

3. The device (1) of claim 2, the light detectors (11-14) further comprising a third detector (13) at a third side of the light-guiding layer (15) for generating a third detection signal y.

4. The device (1) of claim 3, the further information comprising at least one of coordinates of a location of incidence x, y, wherein x is a function of x₁, x₂, and y.

5. The device (1) of claim 3, the further information comprising an angle of incidence that depends linearly on α, wherein tan α is a function of x₁, x₂, and y.

6. The device (1) of claim 2, wherein the light detectors (11-14) comprise a third detector (13) at a third side of the light-guiding layer (15) for generating a third detection signal y₁ and a fourth detector (14) at a fourth side of the light-guiding layer (15) for generating a fourth detection signal y₂, the third and fourth sides being opposite sides.

7. The device (1) of claim 6, wherein the further information comprises at least one of coordinates of a location of incidence x, y, wherein x and y are functions of x₁, x₂, y₁, and y₂.

8. The device (1) of claim 6, wherein the further information comprises at least one of a first angle of incidence and a second angle of incidence, the first angle of incidence depending linearly on α and the second angle of incidence depending linearly on β, wherein tan αand tan β are functions of x₁, x₂, y₁, and y₂.

9. The device (1) of claim 1, further comprising a display monitor (2), and wherein the light-guiding layer (15) comprises an inner side for guiding light arriving at the inner side and originating from the display monitor (2) to the outer side.

10. The device (1) of claim 1, further comprising an adapter (17) for, in response to the further information, adapting a device parameter.

11. The device (1) of claim 10, wherein the device parameter comprises at least one of: a rotation parameter defining a rotation of a 3D object displayed on a display monitor (2); a zooming parameter; a scrolling parameter; a sound volume parameter; an image contrast parameter; an image brightness parameter; a sound optimizing parameter.

12. The device (1) of claim 1, further comprising a selector (18) for, in response to the further information; selecting a user from a plurality of users each one operating his/her own input device (20).

13. A display monitor (2) comprising
a light detector means (11-14) for detecting light and in response generating detection information;
a light-guiding layer (15) comprising an outer side and an inner side for guiding incident light (21) arriving at the outer side and originating from an input device (20) towards the light detector means (11-14) and for guiding light arriving at the inner side and originating from the display monitor (2) to the outer side; and
a converter (16) for converting the detection information into further information for taking into account an angle between the incident light (21) and an axis substantially perpendicular to the light-guiding layer (15).

14. An extension (11-16) comprising
light detector means (11-14) for detecting light and in response generating detection information;
a light-guiding layer (15) comprising an outer side for guiding incident light (21) arriving at the outer side and originating from an input device (20) towards the light detector means (11-14); and
a converter (16) for converting the detection information into further information for taking into account an angle between the incident light (21) and a predetermined direction relative to the light-guiding layer (15).

15. A method for use with light detector means (11-14) for detecting light and in response generating detection information, and with a light-guiding layer (15) comprising an outer side for guiding incident light (21) arriving at the outer side and originating from an input device (20) towards the light detectors (11-14), the method comprising converting the detection information into further information for taking into account an angle between the incident light (21) and a predetermined direction relative to the light-guiding layer (15).

16. A processor program product for use on a data processing system, the system comprising light detector means (11-14) for detecting light and in response generating detection information; and a light-guiding layer (15) that has an outer side for guiding incident light (21) arriving at the outer side and originating from an input device (20) towards the light detectors (11-14), wherein the processor program product comprises converter means to convert the detection information into further information for taking into account an angle between the incident light (21) and a predetermined direction relative to the light-guiding layer (15).
